(19) United States
(12) Patent Application Publication
(10) Pub. No.: US 2025/0070842 A1
(43) Pub. Date: Feb. 27, 2025

(54) MULTI-CARRIER SIGNAL PROCESSING METHOD AND RELATED APPARATUS

(71) Applicant: HUAWEI TECHNOLOGIES CO., LTD., Shenzhen (CN)

(72) Inventors: Paul BRENNAN, London (GB); Kevin CHETTY, London (GB); Fabiola COLONE, London (GB); Rui DU, Singapore (SG); Xiao HAN, Shenzhen (CN)

(21) Appl. No.: 18/945,006

(22) Filed: Nov. 12, 2024

Related U.S. Application Data
(63) Continuation of application No. PCT/CN2023/093619, filed on May 11, 2023.

(30) Foreign Application Priority Data
May 13, 2022 (CN) 202210521903.9

(51) Int. Cl. H04B 7/06; H04W 56/00

(52) U.S. Cl. CPC H04B 7/0626; H04W 56/004

(57) ABSTRACT

This application provides example multi-carrier signal processing methods and example related apparatuses. One example method includes obtaining a first multi-carrier signal. Compensation is performed on the first multi-carrier signal based on a channel state information phase difference of the first multi-carrier signal to obtain a second multi-carrier signal, where a channel state information phase difference of the second multi-carrier signal is zero, or a phase difference of the second multi-carrier signal is zero.

### CROSS-REFERENCE TO RELATED APPLICATIONS

This application is a continuation of International Application No. PCT/CN2023/093619, filed on May 11, 2023, which claims priority to Chinese Patent Application No. 202210521903.9, filed on May 13, 2022. The disclosures of the aforementioned applications are hereby incorporated by reference in their entireties.

### TECHNICAL FIELD

This application relates to the field of communication technologies, and in particular, to a multi-carrier signal processing method and a related apparatus.

### BACKGROUND

Currently, wireless local area network (wireless local area network, WLAN) sensing may use a WLAN signal to sense a passive target or an active target, for example, performing imaging on the passive target or the active target. Generally, in a near-field scenario, that is, when a passive target is located in a near-field range of a receive device, and a signal reflected by the passive target is a spherical wave when arriving at the receive device; or when an active target is located in a near-field range of a receive device, and a signal transmitted by the active target is a spherical wave when arriving at the receive device, the receive device may use a multi-carrier signal to implement imaging on the passive target or the active target. However, because a phase difference of the multi-carrier signal is large, a signal-to-noise ratio of the multi-carrier signal is low. Therefore, how to improve the signal-to-noise ratio of the multi-carrier signal becomes an urgent technical problem to be resolved currently.

### SUMMARY

This application provides a multi-carrier signal processing method and a related apparatus, so that a channel state information phase difference of an obtained second multi-carrier signal is zero. This reduces a group delay of the second multi-carrier signal, and improves a signal-to-noise ratio of the second multi-carrier signal. In this way, imaging effect can be improved when imaging is performed on a passive target or an active target by using the second multi-carrier signal.

According to a first aspect, a multi-carrier signal processing method is provided. The method includes: obtaining a first multi-carrier signal; and performing compensation on the first multi-carrier signal based on a channel state information phase difference of the first multi-carrier signal, to obtain a second multi-carrier signal. A channel state information phase difference of the second multi-carrier signal is zero, or a phase difference of the second multi-carrier signal is zero. It can be learned that, in the foregoing technical solution, the compensation is performed on the first multi-carrier signal based on the channel state information phase difference of the first multi-carrier signal, so that the channel state information phase difference of the obtained second multi-carrier signal is zero, or the phase difference of the second multi-carrier signal is zero. This reduces a group delay of the second multi-carrier signal, and improves a signal-to-noise ratio of the second multi-carrier signal. In this way, imaging effect can be improved when imaging is performed on a passive target or an active target by using the second multi-carrier signal.

Optionally, with reference to the first aspect, the performing compensation on the first multi-carrier signal based on a channel state information phase difference of the first multi-carrier signal, to obtain a second multi-carrier signal includes: performing true time delay compensation on channel state information of the first multi-carrier signal based on the channel state information phase difference of the first multi-carrier signal, to obtain the second multi-carrier signal. It can be learned that, in the foregoing technical solution, the true time delay compensation is performed on the channel state information of the first multi-carrier signal based on the channel state information phase difference of the first multi-carrier signal, so that the channel state information phase difference of the obtained second multi-carrier signal is zero. This reduces a group delay of the second multi-carrier signal, and improves a signal-to-noise ratio of the second multi-carrier signal.

Optionally, with reference to the first aspect, the performing compensation on the first multi-carrier signal based on a channel state information phase difference of the first multi-carrier signal, to obtain a second multi-carrier signal includes: performing phase compensation on the first multi-carrier signal based on the channel state information phase difference of the first multi-carrier signal, to obtain the second multi-carrier signal. It can be learned that, in the foregoing technical solution, the phase compensation is performed on the first multi-carrier signal based on the channel state information phase difference of the first multi-carrier signal, so that the channel state information phase difference of the obtained second multi-carrier signal is zero. This reduces a group delay of the second multi-carrier signal, and improves a signal-to-noise ratio of the second multi-carrier signal.

Optionally, with reference to the first aspect, the performing compensation on the first multi-carrier signal based on a channel state information phase difference of the first multi-carrier signal, to obtain a second multi-carrier signal includes: performing polynomial fit on the first multi-carrier signal based on the channel state information phase difference of the first multi-carrier signal, to obtain the second multi-carrier signal. It can be learned that, in the foregoing technical solution, the polynomial fit is performed on the first multi-carrier signal based on the channel state information phase difference of the first multi-carrier signal, so that the channel state information phase difference of the obtained second multi-carrier signal is zero. This reduces a group delay of the second multi-carrier signal, and improves a signal-to-noise ratio of the second multi-carrier signal.

Optionally, with reference to the first aspect, the performing compensation on the first multi-carrier signal based on a channel state information phase difference of the first multi-carrier signal, to obtain a second multi-carrier signal includes: performing polynomial fit on channel state information of the first multi-carrier signal based on the channel state information phase difference of the first multi-carrier signal, to obtain the second multi-carrier signal. It can be learned that, in the foregoing technical solution, the polynomial fit is performed on the channel state information of the first multi-carrier signal based on the channel state information phase difference of the first multi-carrier signal, so that the channel state information phase difference of the obtained second multi-carrier signal is zero. This reduces a group delay of the second multi-carrier signal, and improves a signal-to-noise ratio of the second multi-carrier signal.

Optionally, with reference to the first aspect, the method further includes: performing imaging based on a plurality of second multi-carrier signals to obtain an imaged image. It can be learned that, in the foregoing technical solution, the channel state information phase difference of the second multi-carrier signal is zero. This reduces a group delay of the second multi-carrier signal, and may further improve a signal-to-noise ratio of the second multi-carrier signal. In this way, imaging effect can be improved when imaging is performed on a passive target or an active target by using the second multi-carrier signal.

Optionally, with reference to the first aspect, the performing imaging based on a plurality of second multi-carrier signals to obtain an imaged image includes: averaging the plurality of second multi-carrier signals to obtain an average of the plurality of second multi-carrier signals; and performing imaging based on the average to obtain the imaged image. It can be learned that, in the foregoing technical solution, the plurality of second multi-carrier signals are averaged, so that an energy value of a multi-carrier signal obtained through coherent averaging is increased. This improves a signal-to-noise ratio of the multi-carrier signal obtained through coherent averaging. In this way, imaging effect can be improved when imaging is performed on a passive target or an active target by using the multi-carrier signal obtained through coherent averaging.

Optionally, with reference to the first aspect, the performing imaging based on a plurality of second multi-carrier signals to obtain an imaged image includes: separately performing imaging based on the plurality of second multi-carrier signals to obtain a plurality of imaged sub-images; and averaging the plurality of imaged sub-images to obtain the imaged image. It can be learned that in the foregoing technical solution, an AP separately performs imaging based on the plurality of second multi-carrier signals to obtain the plurality of imaged sub-images, and averages the plurality of imaged sub-images to obtain the imaged image. This improves imaging effect.

According to a second aspect, a communication apparatus is provided. The communication apparatus includes a module configured to perform any method in the first aspect.

According to a third aspect, a chip is provided. The chip includes at least one processor and an interface, the processor is configured to read and execute instructions stored in a memory, and when the instructions are run, the chip is enabled to perform the method according to any one of the first aspect or the possible implementations of the first aspect.

According to a fourth aspect, a computer-readable storage medium is provided. The computer-readable storage medium stores a computer program, the computer program includes program instructions, and when the program instructions are executed by a computer, the computer is enabled to perform the method according to any one of the first aspect or the possible implementations of the first aspect.

According to a fifth aspect, a communication apparatus is provided, including a processor, a memory, an input interface, and an output interface. The input interface is configured to receive information from another communication apparatus different from the communication apparatus, and the output interface is configured to output information to the another communication apparatus different from the communication apparatus. The processor invokes a computer program stored in the memory to implement the method according to any one of the first aspect or the possible implementations of the first aspect.

In a possible design, the communication apparatus may be a chip or a device including a chip that implements the method in the first aspect.

According to a sixth aspect, a computer program product is provided. When a computer reads and executes the computer program product, the computer is enabled to perform the method according to any one of the first aspect or the possible implementations of the first aspect.

According to a seventh aspect, a communication system is provided, including a device configured to perform the method according to any one of the first aspect or the possible implementations of the first aspect.

### BRIEF DESCRIPTION OF DRAWINGS

The following briefly describes accompanying drawings used for describing embodiments.

FIG. 1 is a diagram of a scenario in which imaging is performed on an active target according to an embodiment of this application;

FIG. 2 is a diagram of a scenario in which imaging is performed on a passive target according to an embodiment of this application;

FIG. 3 is a diagram of a hardware structure of a communication apparatus applicable to an embodiment of this application;

FIG. 4 is a diagram of evenly-spaced deployment of a plurality of APs according to an embodiment of this application;

FIG. 5 is a schematic flowchart of a multi-carrier signal processing method according to an embodiment of this application;

FIG. 6 is a diagram of distribution of channel state information phases of multi-carrier signals according to an embodiment of this application;

FIG. 7 is a diagram of still another type of distribution of channel state information phases of multi-carrier signals according to an embodiment of this application;

FIG. 8 is a diagram of comparison of channel state information phases of multi-carrier signals according to an embodiment of this application;

FIG. 9 is a group delay comparison diagram according to an embodiment of this application;

FIG. 10(a) to FIG. 10(i) each are an imaging effect comparison diagram according to an embodiment of this application;

FIG. 11 is a diagram of imaging effect of three targets after a hamming window is used for a second matrix according to an embodiment of this application;

FIG. 12 is an effect comparison diagram of performing DSI cancellation on an imaged image according to an embodiment of this application;

FIG. 13 is a diagram of imaging effect of three targets in a case in which neither a hamming window nor non-coherent DSI cancellation is used for a second matrix according to an embodiment of this application;

FIG. 14 is a diagram of imaging effect of three targets in a case in which no hamming window is used for a second matrix and non-coherent DSI cancellation is used for the second matrix according to an embodiment of this application;

FIG. 15 is a diagram in which a bandwidth of a continuous wave signal affects imaging according to an embodiment of this application;

FIG. 16 is a diagram of a relationship between a DFF coefficient, a length D of an antenna array, and an incident angle α according to an embodiment of this application;

FIG. 17 is a diagram of a relationship between a smearing factor, a length D of an antenna array, and an incident angle α according to an embodiment of this application; and

FIG. 18 is a diagram of a structure of a communication apparatus according to an embodiment of this application.

### DESCRIPTION OF EMBODIMENTS

The following describes the technical solutions in embodiments of this application with reference to the accompanying drawings in embodiments of this application. Terms “system” and “network” may be used interchangeably in embodiments of this application. “/” represents an “or” relationship between associated objects unless otherwise specified. For example, A/B may represent A or B. The term “and/or” in this application is merely an association relationship for describing associated objects, and represents that three relationships may exist. For example, A and/or B may represent the following three cases: Only A exists, both A and B exist, and only B exists, where A and B each may be singular or plural. In addition, in descriptions of this application, unless otherwise specified, “a plurality of” means two or more than two. “At least one of the following items (pieces)” or a similar expression thereof means any combination of these items, including any combination of singular items (pieces) or plural items (pieces). For example, at least one of a, b, or c may represent a, b, c, a and b, a and c, b and c, or a, b, and c, where a, b, and c may be singular or plural. In addition, to clearly describe the technical solutions in embodiments of this application, the terms such as “first” and “second” are used in embodiment of this application to distinguish between same items or similar items that provide basically same network elements or purposes. A person skilled in the art may understand that the terms such as “first” and “second” do not limit a quantity or an execution sequence, and the terms such as “first” and “second” do not indicate a definite difference.

Reference to “an embodiment”, “some embodiments”, or the like described in embodiments of this application indicates that one or more embodiments of this application include a specific feature, structure, or characteristic described with reference to embodiments. Therefore, statements such as “in an embodiment”, “in some embodiments”, “in some other embodiments”, and “in other embodiments” that appear at different places in this specification do not necessarily mean referring to a same embodiment. Instead, the statements mean “one or more but not all of embodiments”, unless otherwise specifically emphasized in another manner. The terms “include”, “have”, and their variants all mean “include but are not limited to”, unless otherwise specifically emphasized in another manner.

The objectives, technical solutions, and beneficial effect of this application are further described in detail in the following specific implementations. It should be understood that the following descriptions are merely specific implementations of this application, but are not intended to limit the protection scope of this application. Any modification, equivalent replacement, or improvement made based on technical solutions of this application shall fall within the protection scope of this application.

In various embodiments of this application, unless otherwise stated or there is a logic conflict, terms and/or descriptions in different embodiments are consistent and may be mutually referenced, and technical features in different embodiments may be combined based on an internal logical relationship thereof, to form a new embodiment.

The following explains and describes some nouns (or communication terms) in this application. It may be understood that when the following terms are used in other parts of this application, no explanation or description is provided subsequently.

1. A multi-carrier signal may be understood as a signal carried on a plurality of subcarriers. The subcarriers may be classified into data subcarriers and pilot subcarriers. The data subcarrier is used to carry data information from an upper layer. The pilot subcarrier transfers a fixed value, and is used by a receive device to estimate a phase, perform phase correction, and the like.

A phase difference of the multi-carrier signal may be understood as a phase difference of signals carried on a plurality of subcarriers. A channel state information (channel state information, CSI) phase difference of the multi-carrier signal may be understood as a phase difference of a plurality of subcarrier channels.

2. An antenna array is configured to receive and/or send a signal. The antenna array may include at least one antenna array element, and one antenna array element may be understood as one antenna. An arrangement manner of the at least one antenna array element is not limited in this application. For example, the at least one antenna array element may be geometrically evenly distributed, non-uniformly distributed, or randomly geometrically distributed in a linear manner. This is not limited herein.

It should be understood that embodiments of this application may be applicable to a wireless local area network (wireless local area network, WLAN) scenario, and may be applicable to an IEEE 802.11 system standard, for example, 802.11a/b/g, 802.11n, 802.11ac, 802.11ax, or a next-generation of the IEEE 802.11 system standard, for example, 802.11be or a further next-generation of the IEEE 802.11 system standard. Alternatively, embodiments of this application may be applied to a wireless local area network system like an internet of things (internet of things, IoT) network or a vehicle-to-everything (Vehicle to X, V2X) network. Certainly, embodiments of this application may be further applied to another possible communication system, for example, a long term evolution (long term evolution, LTE) system, an LTE frequency division duplex (frequency division duplex, FDD) system, LTE time division duplex (time division duplex, TDD), a universal mobile telecommunications system (universal mobile telecommunications system, UMTS), a worldwide interoperability for microwave access (worldwide interoperability for microwave access, WiMAX) communication system, and a future 6G communication system.

The following uses an example in which embodiments of this application are applicable to a WLAN scenario. It should be understood that, starting from the 802.11a/g standard, the WLAN has experienced 802.11n, 802.11ac, 802.11ax, and 802.11be and Wi-Fi 8 that are currently being discussed. 802.11n can also be referred to as high throughput (high throughput, HT), 802.11ac can also be referred to as very high throughput (very high throughput, VHT), 802.11ax can also be referred to as high efficiency (high efficiency, HE) or Wi-Fi 6, and 802.11be can also be referred to as extremely high throughput (extremely high throughput, EHT) or Wi-Fi 7. Standards before HT, such as 802.11a/b/g, are collectively referred to as non-high throughput (Non-HT).

It should be noted that, in embodiments of this application, an active target or a passive target may be imaged. The active target or the passive target is within a sensing range of a receive device, that is, within a near-field range of the receive device. In this application, the active target may transmit a multi-carrier signal, and a specific device form of the active target is not limited in this application. The passive target may reflect the multi-carrier signal. For example, the passive target may be a person, an animal, a plant, another object, or the like.

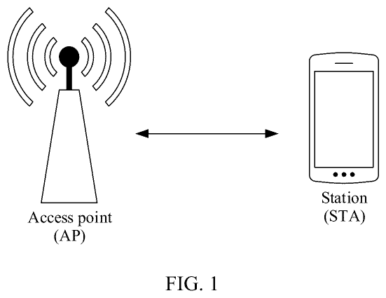

Specifically, FIG. 1 is a diagram of a scenario in which imaging is performed on an active target according to an embodiment of this application. As shown in FIG. 1, a multi-carrier signal transmitted by a wireless access point (access point, AP) in FIG. 1 may be received by a station (station, STA), that is, the AP is an active target, and the STA performs imaging based on the multi-carrier signal transmitted by the AP. In addition, this embodiment of this application is also applicable to communication between APs. For example, the APs may communicate with each other through a distributed system (distributed system, DS), that is, one AP is an active target, and another AP performs imaging based on a multi-carrier signal transmitted by the active target. This embodiment of this application is further applicable to communication between STAs, that is, one STA is an active target, and another STA performs imaging based on a multi-carrier signal transmitted by the active target. It should be understood that quantities of APs and STAs in FIG. 1 are merely an example. There may be more or less APs and STAs.

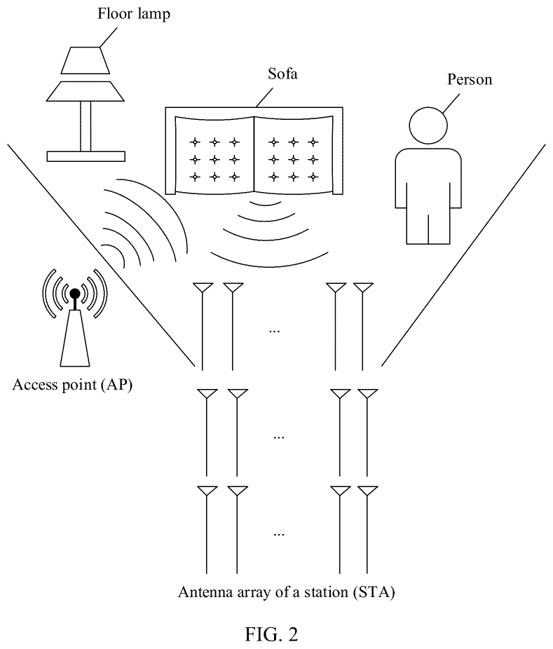

FIG. 2 is a diagram of a scenario in which imaging is performed on a passive target according to an embodiment of this application. As shown in FIG. 2, a near-field range of a STA includes a floor lamp, a sofa, and a person. A multi-carrier signal sent by an AP may be reflected by the sofa, and the multi-carrier signal reflected by the sofa may be received by the STA. For example, the multi-carrier signal reflected by the sofa may be received by an antenna array of the STA. This enables the STA to perform imaging on the sofa.

The STA in embodiments of this application may be various user terminals, user apparatuses, access apparatuses, subscriber stations, subscriber units, mobile stations, user agents, user devices, or other names that have a wireless communication function. The user terminal may include various handheld devices, vehicle-mounted devices, wearable devices, computing devices, or other processing devices connected to a wireless modem that have a wireless communication function; and various forms of user equipment (user equipment, UE), mobile stations (mobile stations, MS's), terminals (terminals), terminal equipment (terminal equipment), portable communication devices, handheld devices, portable computing devices, entertainment devices, game devices or systems, global positioning system devices, any other suitable device configured to perform network communication through a wireless medium, or the like. For example, the STA may be a router, a switch, a bridge, or the like. Herein, for ease of description, the devices mentioned above are collectively referred to as a station or a STA.

The AP and the STA in embodiments of this application may be an AP and a STA that are applicable to an IEEE 802.11 system standard. The AP is an apparatus that is deployed in a wireless communication network and that provides a wireless communication function for a STA associated with the AP. The AP may be used as a center of the communication system, and is usually a network-side product that supports MAC and PHY in the 802.11 system standard, for example, may be a communication device such as a base station, a router, a gateway, a repeater, a communication server, a switch, or a bridge. The base station may include a macro base station, a micro base station, a relay station, or the like in various forms. Herein, for ease of description, the devices mentioned above are collectively referred to as an AP. The STA is usually a terminal product that supports media access control (media access control, MAC) and a physical layer (physical, PHY) of the 802.11 system standard, for example, a mobile phone or a notebook computer.

This solution may be applied to a wireless communication system. The wireless communication system may be a wireless local area network (Wireless local area network) or a cellular network. This solution may be implemented by a communication device in the wireless communication system or a chip or a processor in the communication device. The communication device may be a wireless communication device that supports concurrent transmission performed on a plurality of links. For example, the communication device is referred to as a multi-link device (Multi-link device, MLD) or a multi-band device (multi-band device). Compared with a device that supports only single-link transmission, the multi-link device has higher transmission efficiency and a higher throughput. The multi-link device includes one or more affiliated stations STAs (affiliated STAs). The affiliated STA is a logical station and may work on one link. The affiliated station may be an access point (access point, AP) or a non-access point station (non-access point station, non-AP STA). For ease of description, in this application, a multi-link device whose affiliated station is an AP may be referred to as a multi-link AP, a multi-link AP device, or an AP multi-link device (AP multi-link device), and a multi-link device whose affiliated station is a non-AP STA may be referred to as a multi-link STA, a multi-link STA device, or a STA multi-link device (STA multi-link device). It should be understood that each station in the multi-link device may work on one link, but a plurality of stations are allowed to work on a same link.

Optionally, the devices (such as an AP and a STA) in FIG. 1 or FIG. 2 may be implemented by one device, or may be implemented by a plurality of devices together, or may be a function module in one device. This is not specifically limited in this embodiment of this application. It may be understood that the foregoing function may be a network element in a hardware device, a software function running on dedicated hardware, or a virtualization function instantiated on a platform (for example, a cloud platform).

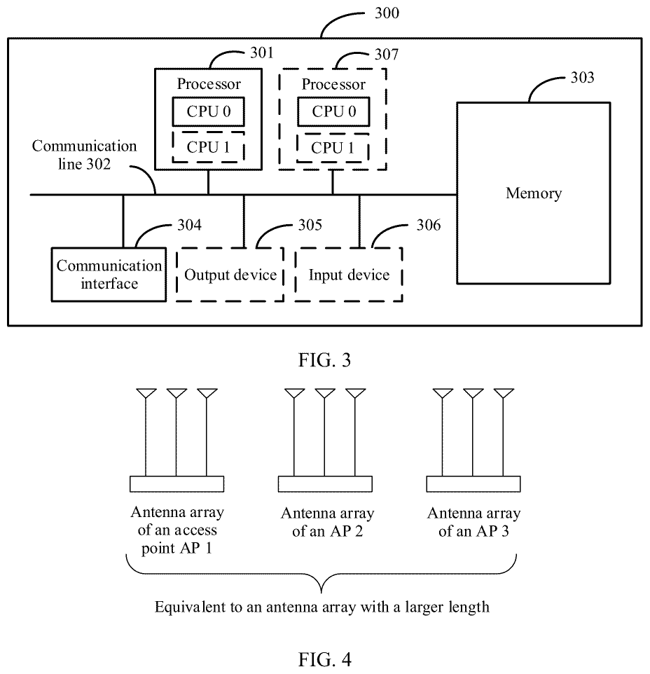

For example, each device in FIG. 1 or FIG. 2 may be implemented by using a communication apparatus 300 in FIG. 3. FIG. 3 is a diagram of a hardware structure of a communication apparatus applicable to an embodiment of this application. The communication apparatus 300 includes at least one processor 301, a communication line 302, a memory 303, and at least one communication interface 304.

The processor 301 may be a general-purpose central processing unit (central processing unit, CPU), a microprocessor, an application-specific integrated circuit (application-specific integrated circuit, ASIC), or one or more integrated circuits configured to control program execution of the solutions of this application.

The communication line 302 may include a path for transmitting information between the foregoing components.

The communication interface 304 is any transceiver-type apparatus (like an antenna), and is configured to communicate with another device or a communication network, for example, the Ethernet, a RAN, or a wireless local area network (wireless local area network, WLAN).

The memory 303 may be a read-only memory (read-only memory, ROM) or another type of static storage device capable of storing static information and instructions, a random access memory (random access memory, RAM) or another type of dynamic storage device capable of storing information and instructions, or may be an electrically erasable programmable read-only memory (electrically erasable programmable read-only memory, EEPROM), a compact disc read-only memory (compact disc read-only memory, CD-ROM) or another compact disc storage, an optical disc storage (including a compressed optical disc, a laser disc, an optical disc, a digital versatile disc, a Blu-ray optical disc, and the like), a magnetic disk storage medium or another magnetic storage device, or any other medium capable of carrying or storing expected program code in a form of instructions or data structures and capable of being accessed by a computer, but is not limited thereto. The memory may exist independently, and is connected to the processor through the communication line 302. The memory may alternatively be integrated with the processor. The memory provided in embodiments of this application may be usually non-volatile.

The memory 303 is configured to store computer-executable instructions for executing the solutions in this application, and the processor 301 controls execution. The processor 301 is configured to execute the computer-executable instructions stored in the memory 303, to implement methods provided in the following embodiments of this application.

Optionally, the computer-executable instructions in this embodiment of this application may also be referred to as application program code. This is not specifically limited in this embodiment of this application.

In a possible implementation, the processor 301 may include one or more CPUs, for example, a CPU 0 and a CPU 1 in FIG. 3.

In a possible implementation, the communication apparatus 300 may include a plurality of processors, for example, the processor 301 and a processor 307 in FIG. 3. Each of the processors may be a single-core (single-CPU) processor, or may be a multi-core (multi-CPU) processor. The processor herein may be one or more devices, circuits, and/or processing cores configured to process data (for example, computer program instructions).

In a possible implementation, the communication apparatus 300 may further include an output device 305 and an input device 306. The output device 305 communicates with the processor 301, and may display information in a plurality of manners. For example, the output device 305 may be a liquid crystal display (liquid crystal display, LCD), a light-emitting diode (light-emitting diode, LED) display device, a cathode ray tube (cathode ray tube, CRT) display device, or a projector (projector). The input device 306 communicates with the processor 301, and may receive an input of a user in a plurality of manners. For example, the input device 306 may be a mouse, a keyboard, a touchscreen device, or a sensor device.

The foregoing communication apparatus 300 may be a general-purpose device or a special-purpose device. In a specific implementation, the communication apparatus 300 may be a desktop computer, a portable computer, a network server, a personal digital assistant (personal digital assistant, PDA), a mobile phone, a tablet computer, a wireless terminal device, an embedded device, or a device having a similar structure in FIG. 3. A type of the communication apparatus 300 is not limited in embodiments of this application.

After the communication apparatus is powered on, the processor 301 may read a software program in the memory 303, interpret and execute instructions of the software program, and process data of the software program. When data needs to be sent wirelessly, the processor 301 performs baseband processing on the to-be-sent data, and then outputs a baseband signal to a radio frequency circuit. The radio frequency circuit performs radio frequency processing on the baseband signal, and then sends, by using the antenna, a radio frequency signal in an electromagnetic wave form. When data is sent to the communication apparatus, the radio frequency circuit receives a radio frequency signal through the antenna, converts the radio frequency signal into a baseband signal, and outputs the baseband signal to the processor 301; and the processor 301 converts the baseband signal into data, and processes the data.

In another implementation, the radio frequency circuit and the antenna may be disposed independent of the processor that performs baseband processing. For example, in a distributed scenario, the radio frequency circuit and the antenna may be remotely disposed independent of the communication apparatus.

The following describes the technical solutions provided in embodiments of this application by using a first device as an execution body with reference to the accompanying drawings. The first device may be an AP or a STA. It should be understood that, in this application, the first device may perform imaging on an active target or a passive target. That the first device performs imaging on the active target may be understood as: The first device performs imaging on a second device, and the second device may be an AP or a STA.

Optionally, imaging resolution in this solution is related to a quantity of antenna array elements of the first device, and a longer array indicates a larger quantity of antenna array elements and higher imaging resolution. Therefore, when a quantity of antenna array elements of one first device cannot meet the imaging resolution, the device may move by a specific length due to mobility of the device, so that different first devices receive echo signals at different locations at equal intervals, that is, a plurality of first devices are deployed at equal intervals. In this case, antenna arrays of the plurality of first devices are equivalent to an antenna array with a larger length, so that the imaging resolution can be met. In other words, in this application, the antenna arrays of the plurality of first devices may be equivalent to the antenna array with the larger length based on a synthetic aperture principle, to form a large aperture. For example, FIG. 4 is a diagram of evenly-spaced deployment of a plurality of APs according to an embodiment of this application. As shown in FIG. 4, a distance between an AP 1 and an AP 2 is the same as a distance between the AP 2 and an AP 3, that is, three APs are deployed at equal intervals, so that antenna arrays of the three APs are equivalent to an antenna array with a larger length.

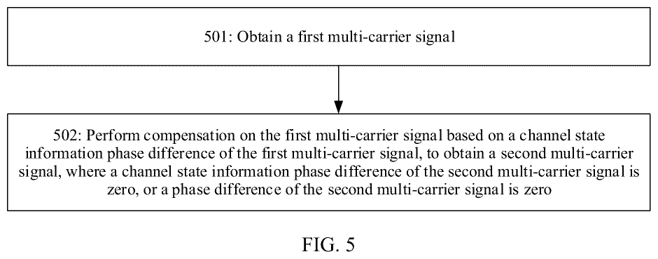

The following describes the technical solutions provided in embodiments of this application by using an example in which a first device is an AP and a second device is a STA. FIG. 5 is a schematic flowchart of a multi-carrier signal processing method according to an embodiment of this application. As shown in FIG. 5, the method includes but is not limited to the following steps.

501: An AP obtains a first multi-carrier signal.

In a possible implementation, step 501 may include: The AP receives a first multi-carrier signal sent by a STA. For example, the AP receives, by using an antenna array, the first multi-carrier signal sent by the STA. Correspondingly, the STA may send the first multi-carrier signal to the AP. In another possible implementation, step 501 may include: The AP receives the first multi-carrier signal reflected by a passive target. That is, the AP receives, by using an antenna array, the first multi-carrier signal that is from the STA and that is reflected by the passive target.

Optionally, there may be one or more first multi-carrier signals, the antenna array may include at least one antenna array element, one antenna array element may receive one first multi-carrier signal, and path losses of the first multi-carrier signals received by different antenna array elements are different. It should be understood that, in this solution, a manner of processing a first multi-carrier signal received by any antenna array element in the antenna array is similar, and details are not described herein again.

502: The AP performs compensation on the first multi-carrier signal based on a channel state information phase difference of the first multi-carrier signal, to obtain a second multi-carrier signal, where a channel state information phase difference of the second multi-carrier signal is zero, or a phase difference of the second multi-carrier signal is zero.

Channel state information phases of the first multi-carrier signal may be linearly distributed or non-linearly distributed.

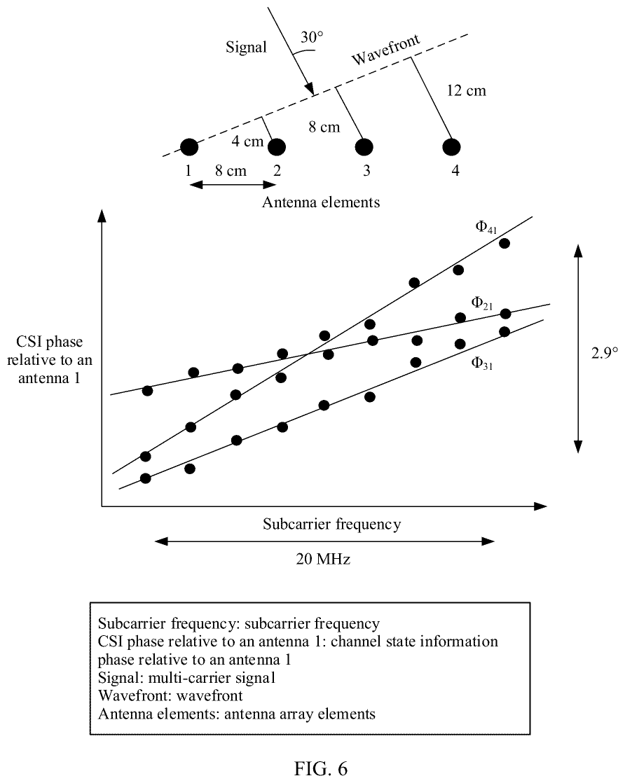

For example, FIG. 6 is a diagram of distribution of channel state information phases of multi-carrier signals according to an embodiment of this application. In FIG. 6, an angle a multi-carrier signal on a wavefront in a bandwidth of 20 megahertz (MHz) is 30°, a distance between an antenna 1 and an antenna 2 is 8 centimeters (cm), and a maximum channel state information phase difference of the multi-carrier signal is 2.9°. It may be understood that, channel state information phases of a multi-carrier signal corresponding to a same antenna are linearly distributed. As shown in FIG. 6, channel state information phase differences of multi-carrier signals corresponding to three antennas are φ₄₁, φ₂₁, and φ₃₁ respectively. In addition, the AP may further determine path lengths (path length) and delays (time delay) of multi-carrier signals corresponding to different antennas. The delays may also be referred to as a group delay. A path length is

$$L = \frac{c}{2 π} \frac{d φ}{df} ,$$

a delay is

$$T = \frac{1}{2 π} \frac{d φ}{df} ,$$

φ is a channel state information phase difference of a multi-carrier signal, f is a frequency of the multi-carrier signal, and c is a speed of light. In FIG. 6, when the channel state information phase difference of the multi-carrier signal is φ₄₁, a path length is 12 centimeters, and a delay is 0.4 nanoseconds (ns); when the channel state information phase difference of the multi-carrier signal is φ₂₁, a path length is 4 centimeters, and a delay is 0.13 nanoseconds; and when the channel state information phase difference of the multi-carrier signal is φ₃₁, a path length is 8 centimeters, and a delay is 0.27 nanoseconds.

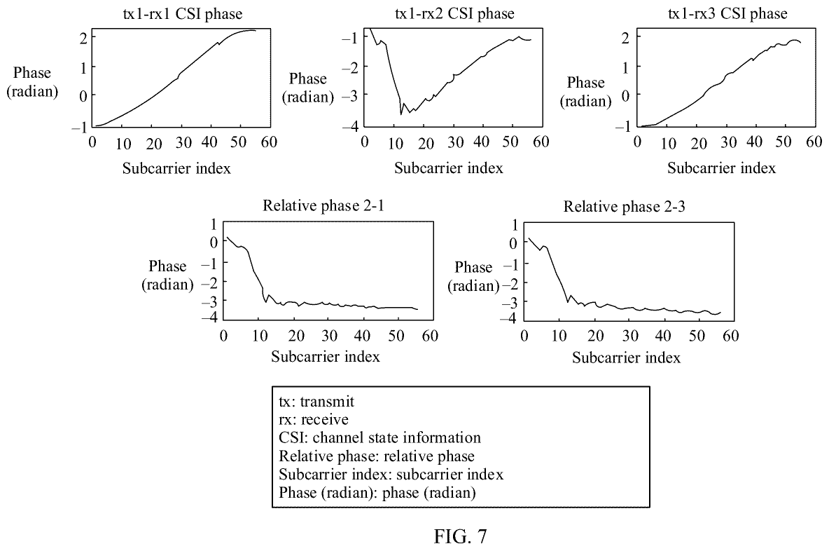

For another example, FIG. 7 is a diagram of still another type of distribution of channel state information phases of multi-carrier signals according to an embodiment of this application. Due to impact of multipath and dispersion, a slope of a subcarrier phase may be non-linear. As shown in FIG. 7, slopes of all subcarrier phases corresponding to transmit (tx) 1-receive (rx) 1 are non-linear, slopes of all subcarrier phases corresponding to tx1-rx2 are non-linear, and slopes of all subcarrier phases corresponding to tx1-rx3 are non-linear. It should be understood that, because the slope of the subcarrier phase is non-linear, a channel state information phase difference between subcarriers on a same frame may be unstable. As shown in FIG. 7, channel state information phases of multi-carrier signals corresponding to tx1-rx2 and tx1-rx1 are non-linearly distributed, that is, channel state information phases of multi-carrier signals in an image corresponding to a relative phase (relative phase 2-1) in FIG. 7 are non-linearly distributed; and in FIG. 7, channel state information phases of multi-carrier signals corresponding to tx1-rx2 and tx1-rx3 are non-linearly distributed, that is, channel state information phases of multi-carrier signals in an image corresponding to a relative phase 2-3 in FIG. 7 are non-linearly distributed.

Optionally, when the channel state information phases of the first multi-carrier signal are linearly distributed, step 502 may be implemented in any one of the following manners.

Manner 1.1: The AP performs true time delay (true time delay, TDD) compensation on channel state information of the first multi-carrier signal based on the channel state information phase difference of the first multi-carrier signal, to obtain the second multi-carrier signal.

Manner 1.2: The AP performs phase compensation on the first multi-carrier signal based on the channel state information phase difference of the first multi-carrier signal, to obtain the second multi-carrier signal.

Optionally, the channel state information phase difference of the first multi-carrier signal in Manner 1.1 and Manner 1.2 may be obtained based on slopes of phases of a plurality of subcarriers. For example, yₙ and xₙ respectively represent a phase and a frequency that are of an n^{th} subcarrier in the plurality of subcarriers, and n is an integer greater than or equal to 1. It is assumed that there is a linear relationship between yₙ and xₙ, for example, yₙ=axₙ+b, where a represents a slope, and b represents an intercept. The yₙ=axₙ+b represented in a form of a matrix is as follows:

$$[ \begin{matrix}{y}_{1} \\ {y}_{1} \\ ⋮ \\ {y}_{n}\end{matrix} ] = a [ \begin{matrix}{x}_{1} \\ {x}_{2} \\ ⋮ \\ {x}_{n}\end{matrix} ] + b \to [ \begin{matrix}{y}_{1} \\ {y}_{1} \\ ⋮ \\ {y}_{n}\end{matrix} ] = [ \begin{matrix}{x}_{1} & 1 \\ {x}_{2} & 1 \\ ⋮ & 1 \\ {x}_{n} & 1\end{matrix} ] [ \begin{matrix}a \\ b\end{matrix} ] ,$$

that is, y̅=Xā. If y̅=Xā is compatible, ā=X⁻¹y̅ may be obtained by performing inversion on the matrix; and if y̅=Xā is incompatible, a fitting solution ā=(X^{H}X)⁻¹X^{H}y̅ with a minimum mean square error may be obtained through least squares estimation. A residual of the vector ā is δā=X⁻¹*ā−y̅, and a slope and an intercept of an optimal fitted regression line are

$$\overline{a} = [ \begin{matrix}a \\ b\end{matrix} ] .$$

Optionally, when the channel state information phases of the first multi-carrier signal are non-linearly distributed, step 502 may be implemented in any one of the following manners.

Manner 2.1: The AP performs polynomial fit on the first multi-carrier signal based on the channel state information phase difference of the first multi-carrier signal, to obtain the second multi-carrier signal.

Manner 2.2: The AP performs polynomial fit on channel state information of the first multi-carrier signal based on the channel state information phase difference of the first multi-carrier signal, to obtain the second multi-carrier signal.

Optionally, a polynomial in either Manner 2.1 or Manner 2.2 may be a polynomial of different orders, for example, a third-order polynomial.

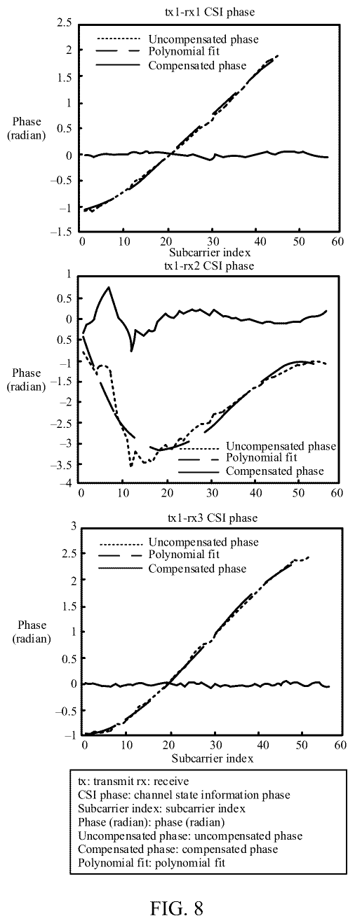

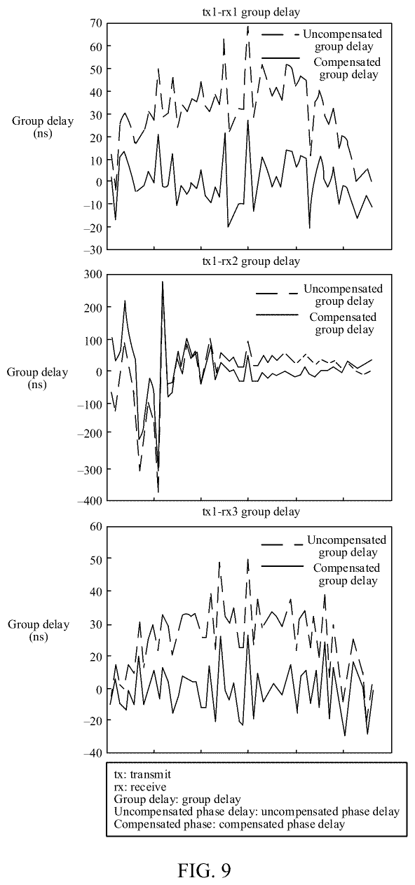

For example, FIG. 8 is a diagram of comparison of channel state information phases of multi-carrier signals according to an embodiment of this application. An uncompensated phase is a channel state information phase of the multi-carrier signal in a case in which polynomial fit is not performed on channel state information of the multi-carrier signal, and a compensated phase is a channel state information phase of the multi-carrier signal in a case in which polynomial fit is performed on the channel state information of the multi-carrier signal. In FIG. 8, polynomial fit may be performed on the channel state information of multi-carrier signals on three paths (tx1-rx1, tx1-rx2, and tx1-rx3) in possible six paths of a three-channel network adapter. Specifically, a curve of an uncompensated phase (uncompensated phase) corresponding to tx1-rx1 may be fitted by using a third-order polynomial fit (polynomial fit) curve, to obtain a curve of a compensated phase (compensated phase) corresponding to tx1-rx1. It can be learned that values of the curve of the compensated phase corresponding to tx1-rx1 on a vertical coordinate are almost the same. This is similar to tx1-rx2 and tx1-rx3, and details are not described herein again.

For either of Manner 2.1 and Manner 2.2, a non-linear phase-frequency characteristic in an entire frequency band may be compensated through polynomial fit, to obtain a low group delay. Specifically, the group delay may be:

$$Group delay = \frac{1}{2 π} \frac{d ϕ}{df} ,$$

where φ is the channel state information phase difference of the first multi-carrier signal, and f is a frequency of the first multi-carrier signal.

For example, FIG. 9 is a group delay comparison diagram according to an embodiment of this application. As shown in FIG. 9, values of a curve of uncompensated phase delays (uncompensated phase delay) corresponding to tx1-rx1 on a vertical coordinate are mostly higher than values of a curve of compensated phase (compensated phase) delays corresponding to tx1-rx1 on the vertical coordinate. This is similar to tx1-rx2 and tx1-rx3, and details are not described herein again. To better evaluate effect of improving a signal-to-noise ratio (signal-to-noise ratio, SNR) by a multi-carrier signal on which polynomial fit is performed, a coherent combination loss factor (coherent combination loss factor, CCLF) before and after group delay compensation is used as an evaluation standard.

$$CCLF = \vert \frac{1}{N} {\sum }_{1}^{N} {e}^{j ϕ} \vert ,$$

where N is a quantity of subcarriers, j is an imaginary unit, and ϕ is a channel state information phase of a multi-carrier signal in a case in which polynomial fit is not performed on channel state information of the multi-carrier signal, or a channel state information phase of a multi-carrier signal in a case in which polynomial fit is performed on channel state information of the multi-carrier signal.

TABLE 1

| | Without group | With group delay |
|---|---|---|
| | delay compensation | compensation |
| | (without group | (with group |
| | delay compensation) | delay compensation) |
| CCLF₁₁ | 0.45 (−6.9 dB) | 1.00 (0.00 dB) |
| CCLF₁₂ | 0.68 (−3.3 dB) | 0.97 (−0.24 dB) |
| CCLF₁₃ | 0.39 (−8.2 dB) | 1.00 (0.00 dB) |
| CCLF Total | 0.51 (−5.9 dB) | 0.99 (−0.1 dB) |

In Table 1, the uncompensated group delay may be understood as a group delay corresponding to a multi-carrier signal in a case in which polynomial fit is not performed on channel state information of the multi-carrier signal, and the compensation group delay may be understood as a group delay corresponding to a multi-carrier signal in a case in which polynomial fit is performed on channel state information of the multi-carrier signal. CCLF₁₁ represents a CCLF corresponding to tx1-rx1, CCLF₁₂ represents a CCLF corresponding to tx1-rx2, CCLF₁₃ represents a CCLF corresponding to tx1-rx3, and CCLF Total represents a total CCLF corresponding to tx1-rx1, tx1-rx2, and tx1-rx3. With reference to Table 1, it can be learned that, for tx1-rx1, a CCLF without group delay compensation is 0.45, and this value converted into dB is −6.9 dB; and a CCLF with group delay compensation is 1, and this value converted into dB is 0.00 dB. For tx1-rx2, a CCLF without group delay compensation is 0.39, and this value converted into dB is −3.3 dB; and a CCLF with group delay compensation is 0.97, and this value converted into dB is 0.24 dB. For tx1-rx3, a CCLF without group delay compensation is 0.39, and this value converted into dB is −8.2 dB; and a CCLF with group delay compensation is 1, and this value converted into dB is 0.00 dB. Therefore, the coherent combination loss factor without group delay compensation is lower than the coherent combination loss factor with group delay compensation. In addition, it can be learned that a sum of the coherent combination loss factors (CCLF Total) without group delay compensation is 0.51, and this value converted into dB is −5.9 dB; a sum of the coherent combination loss factors (CCLF Total) with group delay compensation is 0.99, and this value converted into dB is −0.1 dB, that is, the sum of the coherent combination loss factors without group delay compensation is also less than the sum of the coherent combination loss factors with group delay compensation.

It can be learned that, for any one of Manner 1.1, Manner 1.2, Manner 2.1, and Manner 2.2, the compensation is performed on the first multi-carrier signal based on the channel state information phase difference of the first multi-carrier signal, so that the channel state information phase difference of the obtained second multi-carrier signal is zero. This reduces a group delay of the second multi-carrier signal, and improves a signal-to-noise ratio of the second multi-carrier signal.

It can be learned that, in the foregoing technical solution, compensation is performed on the first multi-carrier signal based on the channel state information phase difference of the first multi-carrier signal, so that the channel state information phase difference of the obtained second multi-carrier signal is zero, or the phase difference of the second multi-carrier signal is zero. This reduces a group delay of the second multi-carrier signal, and improves a signal-to-noise ratio of the second multi-carrier signal. In this way, imaging effect can be improved when imaging is performed on a passive target or an active target by using the second multi-carrier signal.

Optionally, the method may further include: The AP performs imaging based on a plurality of second multi-carrier signals, to obtain an imaged image. For example, if the AP receives, in step 501, the first multi-carrier signal sent by the STA, the AP may perform imaging on the STA based on the plurality of second multi-carrier signals, to obtain an imaged image of the STA. If the AP receives the first multi-carrier signal reflected by the passive target in step 501, the AP may perform imaging on the passive target based on the plurality of second multi-carrier signals, to obtain an imaged image of the passive target.

It can be learned that, in the foregoing technical solution, the channel state information phase difference of the second multi-carrier signal is zero. This reduces a group delay of the second multi-carrier signal, and may further improve a signal-to-noise ratio of the second multi-carrier signal. In this way, imaging effect can be improved when imaging is performed on a passive target or an active target by using the second multi-carrier signal.

In a possible implementation, that the AP performs imaging based on a plurality of second multi-carrier signals, to obtain an imaged image may include: The AP averages the plurality of second multi-carrier signals, to obtain an average of the plurality of second multi-carrier signals; and the AP performs imaging based on the average, to obtain the imaged image.

One second multi-carrier signal may be divided into a real part and an imaginary part, an amplitude of the second multi-carrier signal is a positive square root of a sum of squares of the real part and the imaginary part, and a phase of the second multi-carrier signal is an arc tangent value of a ratio of the imaginary part to the real part. Optionally, that the AP averages the plurality of second multi-carrier signals, to obtain an average of the plurality of second multi-carrier signals may include: The AP averages amplitudes of the plurality of second multi-carrier signals, to obtain an average of the amplitudes of the plurality of second multi-carrier signals; and the AP averages phases of the plurality of second multi-carrier signals, to obtain an average of the phases of the plurality of second multi-carrier signals. It should be understood that the AP averages the plurality of second multi-carrier signals in a coherent manner.

Optionally, that the AP performs imaging based on the average, to obtain the imaged image may include: The AP determines a first matrix based on the average of the amplitudes of the plurality of second multi-carrier signals and the average of the phases of the plurality of second multi-carrier signals, where the first matrix includes the average of the amplitudes of the plurality of second multi-carrier signals, the average of the phases of the plurality of second multi-carrier signals, and at least one antenna array element of the AP; and performs a dot product operation on the first matrix and a second matrix, to obtain the imaged image. The second matrix includes amplitude attenuation of all multi-carrier signals in an environment within a sensing range of the AP, phase differences of all the multi-carrier signals in the environment within the sensing range of the AP, and at least one antenna array element of the AP.

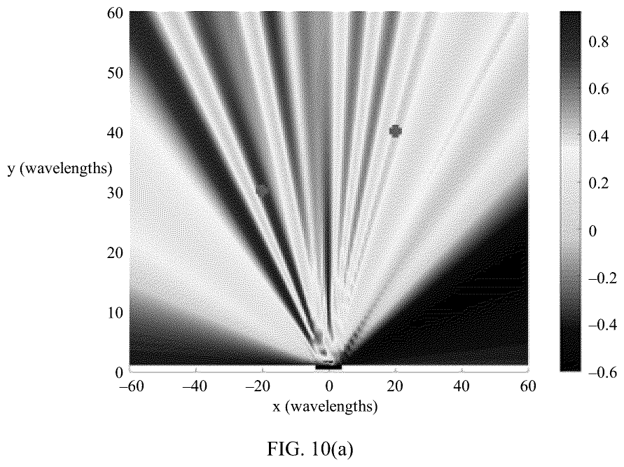

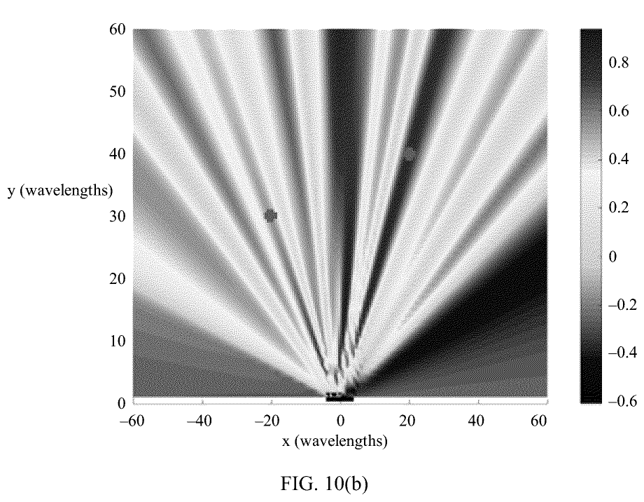

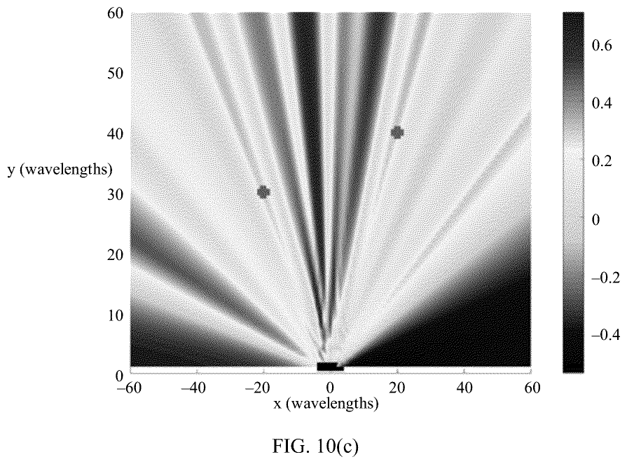

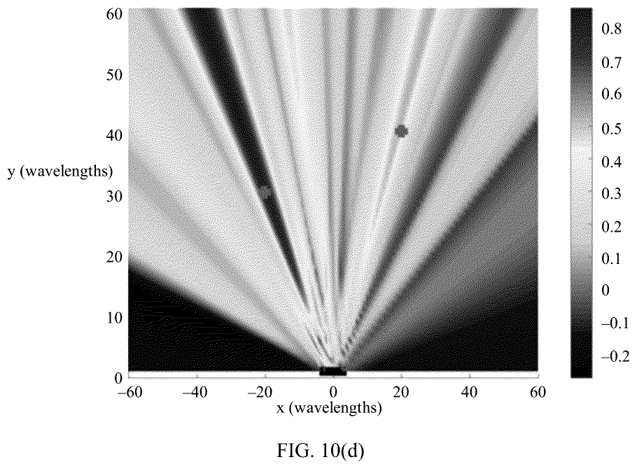

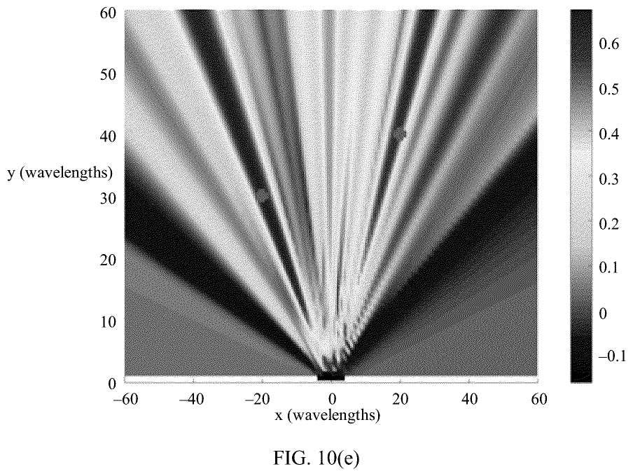

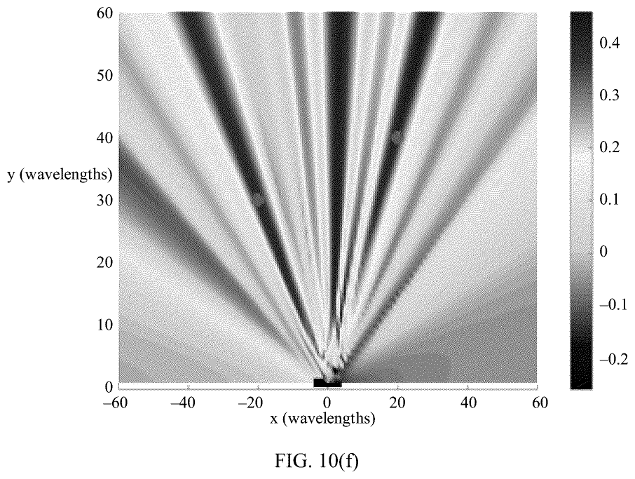

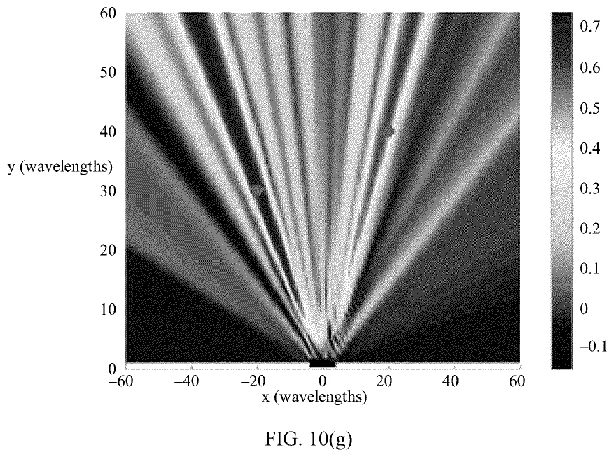

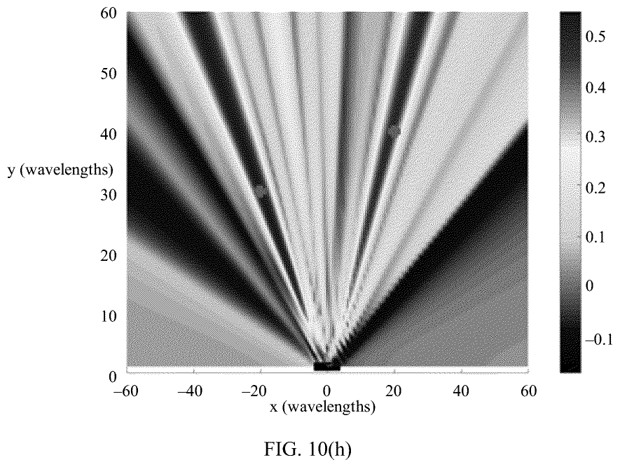

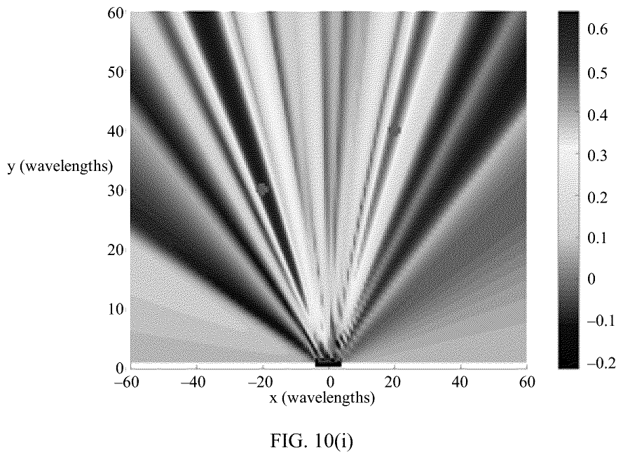

For example, FIG. 10(a) to FIG. 10(i) each are an imaging effect comparison diagram according to an embodiment of this application. In FIG. 10(a) to FIG. 10(i), a quantity of antenna array elements is 10, a quantity of subcarriers included in a single carrier is 1, a quantity of subcarriers included in a multi-carrier is 56, and a frequency band is 20 MHz. With reference to FIG. 10(a) to FIG. 10(i), it can be learned that definition of an image corresponding to a single carrier signal is the lowest, definition of an image of a multi-carrier signal is the second highest in a case in which polynomial fit is not performed on channel state information of the multi-carrier signal and averaging is not performed, and definition of an image of the multi-carrier signal is the best in a case in which polynomial fit is performed on the channel state information of the multi-carrier signal and multi-carrier signals obtained after the polynomial fit are averaged. In addition, in a case in which polynomial fit is not performed on the channel state information of the multi-carrier signal and averaging is not performed, a phase change of ±100° exists in the channel state information of the multi-carrier signal, and a CCLF is 5.9 dB. In a case in which polynomial fit is performed on the channel state information of the multi-carrier signal, and multi-carrier signals obtained after the polynomial fit are averaged, a CCLF is 0.1 dB, and 0.1 dB is less than 5.9 dB.

It can be learned that, in the foregoing technical solution, the plurality of second multi-carrier signals are averaged, so that an energy value of a multi-carrier signal obtained through coherent averaging is increased. This improves a signal-to-noise ratio of the multi-carrier signal obtained through coherent averaging. In this way, imaging effect can be improved when imaging is performed on a passive target or an active target by using the multi-carrier signal obtained through coherent averaging.

In another possible implementation, that the AP performs imaging based on a plurality of second multi-carrier signals, to obtain an imaged image may include: The AP separately performs imaging based on the plurality of second multi-carrier signals to obtain a plurality of imaged sub-images; and the AP averages the plurality of imaged sub-images, to obtain the imaged image. It should be understood that the AP averages the plurality of imaged sub-images in a non-coherent manner.

Optionally, that the AP separately performs imaging based on the plurality of second multi-carrier signals to obtain a plurality of imaged sub-images may include: The AP determines a plurality of third matrices based on the plurality of second multi-carrier signals, where one third matrix includes an amplitude of one second multi-carrier signal, a phase of the second multi-carrier signal, and at least one antenna array element of the AP; and performs a dot product operation on the second matrix and each of the plurality of third matrices, to obtain the plurality of imaged sub-images.

It can be learned that in the foregoing technical solution, the AP separately performs imaging based on the plurality of second multi-carrier signals to obtain the plurality of imaged sub-images, and averages the plurality of imaged sub-images to obtain the imaged image. This improves imaging effect.

Optionally, in this application, the second matrix may be a second matrix using a window function. For example, the window function may be a Hamming window, a Hanning window, or the like. It should be understood that, because the second matrix is the second matrix using the window function, impact of side lobes can be reduced.

For example, refer to Table 2. The following three targets in an environment within a sensing range of the AP need to be imaged.

TABLE 2

| | Coordinate | Amplitude of a multi-carrier signal |
|---|---|---|
| Target 1 | (−20, 30) λ | 0.5 |
| Target 2 | (20, 40) λ | 0.5 |
| Target 3 | (40, 15) λ | 1 |

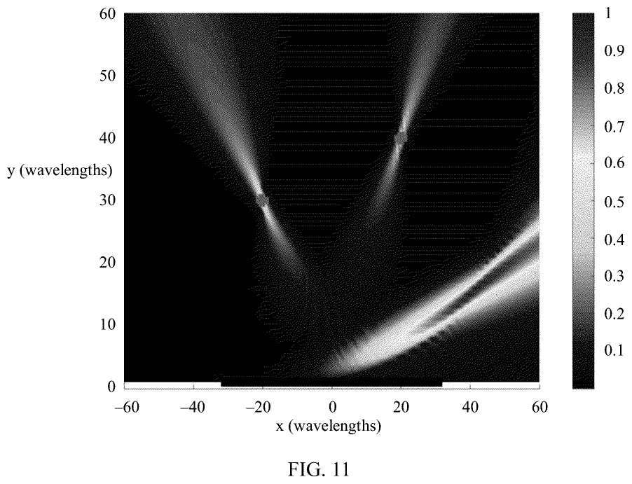

Coordinates of the three targets are all normalized based on signal wavelengths, and the target 1 and the target 2 may reflect a multi-carrier signal sent by the target 3. The target 3 is a transmit end, and an antenna array of the transmit end is 64 wavelengths long, and there are 128 antenna array elements in total. FIG. 11 is a diagram of imaging effect of three targets after a hamming window is used for a second matrix according to an embodiment of this application. In FIG. 11, because the second matrix uses the hamming window, side lobes are greatly suppressed. Second, angular resolution and distance resolution can reach 0.9° and 1.6λ over a 40-wavelength range. However, in FIG. 11, a direct signal is very obvious, but the direct signal does not affect detection, identification, and positioning of the target.

To avoid direct signal interference, optionally, the method may further include: The AP performs direct signal interference (direct signal interference, DSI) cancellation on the imaged image, to obtain an imaged image with interference eliminated.

The AP may perform the DSI cancellation on the imaged image in a coherent or non-coherent manner.

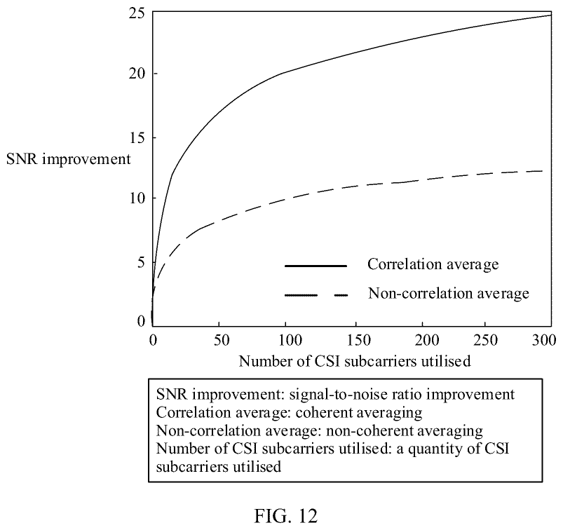

It should be understood that, because the AP averages the plurality of second multi-carrier signals in a coherent manner, effect of performing DSI cancellation on the imaged image in a non-coherent manner is better than effect of performing DSI cancellation on the imaged image in a coherent manner. For example, FIG. 12 is an effect comparison diagram of performing DSI cancellation on an imaged image according to an embodiment of this application. As shown in FIG. 12, as a quantity of subcarriers increases, although a signal-to-noise ratio increases monotonically in both a coherent case and a non-coherent case, a signal-to-noise ratio in a coherent manner is far greater than a signal-to-noise ratio in a non-coherent manner. That is, effect of performing DSI cancellation on the imaged image in a non-coherent manner is better than effect of performing DSI cancellation on the imaged image in a coherent manner. It should be noted that, in FIG. 12, coherent averaging (correlation average) may be understood as: performing DSI cancellation on the imaged image in a coherent manner; and non-coherent averaging (non-correlation average) may be understood as: performing DSI cancellation on the imaged image in a non-coherent manner.

Generally, a directional antenna may be used to suppress interference of a direct signal (namely, a STA) transmitted by a transmit end. Specifically, the directional antenna is adjusted, so that the direct signal of the transmit end is located on a side surface or behind an antenna array, or a zero gain point in the antenna array is directed to the transmit end, or a technology similar to a type of moving target display (moving target display, MTI) for reducing static environmental signals is used to suppress interference of a clutter and the direct signal. For example, infinite impulse response high pass filtering.

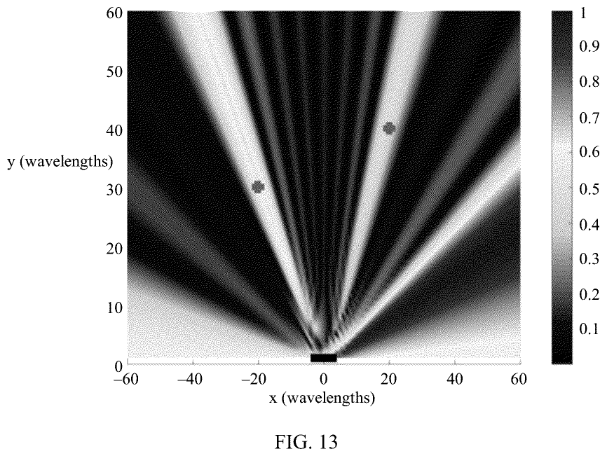

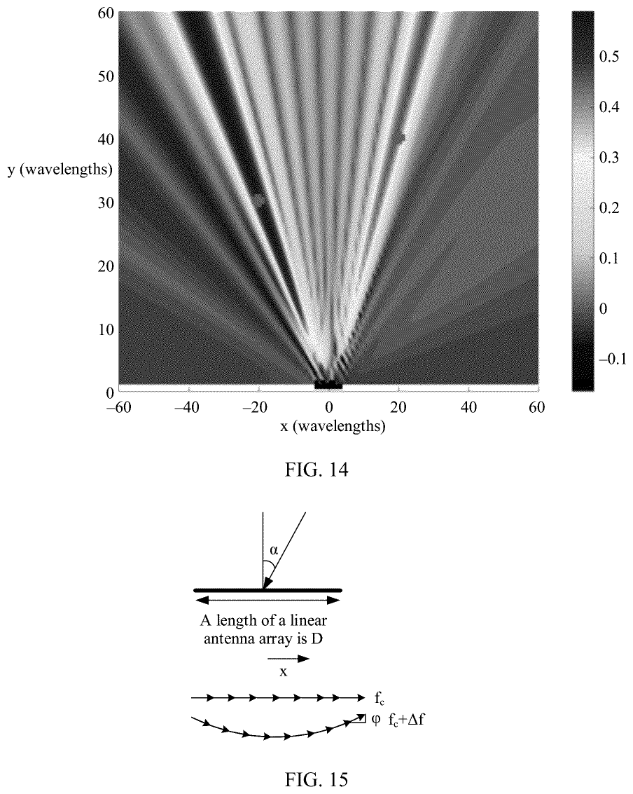

For another example, refer to FIG. 13 and FIG. 14. FIG. 13 is a diagram of imaging effect of three targets in a case in which neither a hamming window nor non-coherent DSI cancellation is used for a second matrix according to an embodiment of this application. FIG. 14 is a diagram of imaging effect of three targets in a case in which no hamming window is used for a second matrix and non-coherent DSI cancellation is used for the second matrix according to an embodiment of this application. In FIG. 13 and FIG. 14, in a frequency band of 5 GHz to 6 GHZ, an antenna array at a transmit end has a length of about 8 wavelengths (41 cm in 5.8 GHz). Because the second matrix does not use the hamming window, there is a side lobe. It can be learned with reference to FIG. 13 that, when the non-coherent DSI cancellation is not used, a direction of the target may still be detected. In addition, with reference to FIG. 11 and FIG. 14, it can be learned that imaging resolution of the 8-wavelength antenna array is significantly reduced compared with that of a 64-wavelength antenna array. Therefore, this technical solution may be more applicable to a high frequency band range.

In addition, this solution is also applicable to a continuous wave signal, that is, the multi-carrier signal in FIG. 5 is replaced with the continuous wave signal, and the AP is replaced with a terminal device. Imaging performance is limited by a bandwidth when the continuous wave signal is used. For example, FIG. 15 is a diagram in which a bandwidth of a continuous wave signal affects imaging according to an embodiment of this application. As shown in FIG. 15, for a continuous wave signal whose frequency is f_{c}, due to impact of a near field, signals received between antenna arrays have a frequency difference Δf. It is assumed that a linear antenna array of a terminal device includes at least one antenna array element, and a change that is of path lengths of the continuous wave signal arriving at different antenna array elements and that is relative to an array center is: ΔL=x sin α, where −D/2≤x≤D/2, D is a length of the linear antenna array, and a is an included angle between a direction of arrival of the continuous wave signal and a direction perpendicular to the linear antenna array, namely, an incident angle.

Correspondingly, a phase difference between different antenna array elements is

$$Δ ϕ = \frac{2 π}{c / Δ f} x sin α = \frac{2 π x Δ f}{c} sin α ,$$

and c is a speed of light.

Due to a limited signal bandwidth, a de-focusing factor (de-focusing factor, DFF) of the continuous wave signal in the worst case may be obtained by averaging arrays and bandwidths, that is,

$$DFF = \frac{2}{D} {\int }_{x = 0}^{D / 2} \frac{2}{B} {\int }_{Δ f = 0}^{B / 2} cos ( \frac{2 π x Δ f}{c} sin α ) d ( Δ f ) dx .$$

An azimuth beam width of the continuous wave signal may be obtained through

$$BW = \frac{λ}{D cos α} .$$

Then, for DFF, an inner integral is first calculated, and then transformation

$$y = \frac{π Bx}{c} sin α$$

is performed, and finally,

$$DFF = \frac{2 c}{π DB sin α} {\int }_{0}^{\frac{π DB sin α}{2 c}} \frac{sin y}{y} dy = \frac{2 c}{π DB sin α} {S}_{i} ( \frac{π DB sin α}{2 c} )$$

is obtained, where Sᵢ(⋅) is a sinc integral function.

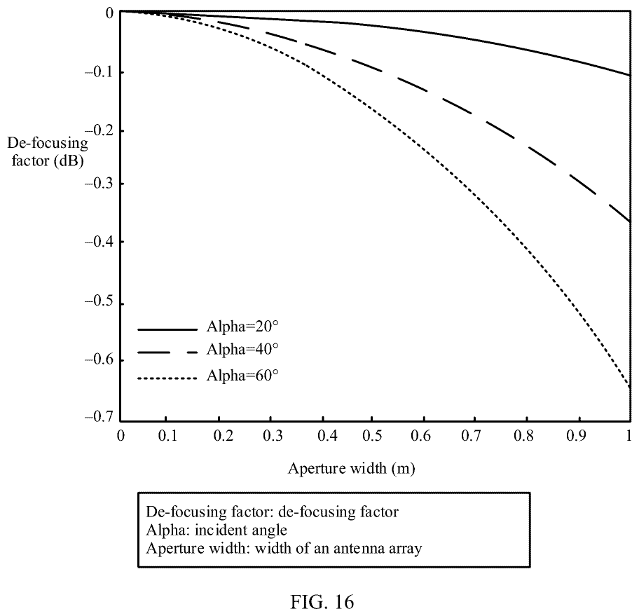

The following describes, with reference to FIG. 16, a relationship between a DFF coefficient, a length D of an antenna array, and an incident angle α. As shown in FIG. 16, for a frequency band of 5 GHz, the frequency band has a maximum bandwidth of 255 MHz, and a length of an antenna array is up to 1 m. For the antenna array with a width of 1 m, a maximum DFF coefficient may be −0.64 dB due to a limited signal bandwidth when an incident angle of a signal is 60°. However, in practice, a length of an antenna array is usually less than 1 m. For an antenna array that is more suitable for actual and that has a length of 0.4 m, a DFF coefficient is −0.10 dB, which can be ignored.

In addition, a limited signal bandwidth also expands a beam width of an antenna array in an azimuth, resulting in transverse smearing of active or passive targets in the imaged image. A change Δ sin α of a pointing direction is related to a change Δf of a center frequency, that is,

$$\frac{Δ sin α}{sin α} = \frac{Δ f}{{f}_{c}} \to Δα cos α = \frac{Δ f}{{f}_{c}} sin α .$$

However, the limited signal bandwidth can widen the active or passive targets in the imaged image to Aa and reduce linear response to half of a peak amplitude BW+Δα/2. Therefore, a smearing factor (smearing factor) may be defined as a ratio of transverse distance resolution of a limited signal bandwidth to transverse distance resolution of a continuous wave signal, that is,

$$smearing factor = \frac{BW + Δ α / 2}{BW} = \frac{\frac{λ}{D cos α} + \frac{Δ f}{2 {f}_{c}} sin α}{\frac{λ}{D cos α}} = 1 + \frac{D Δ f}{2 c} sin α .$$

When a signal is vertically incident (α=) 90°, the smearing factor is 1, which is reasonable.

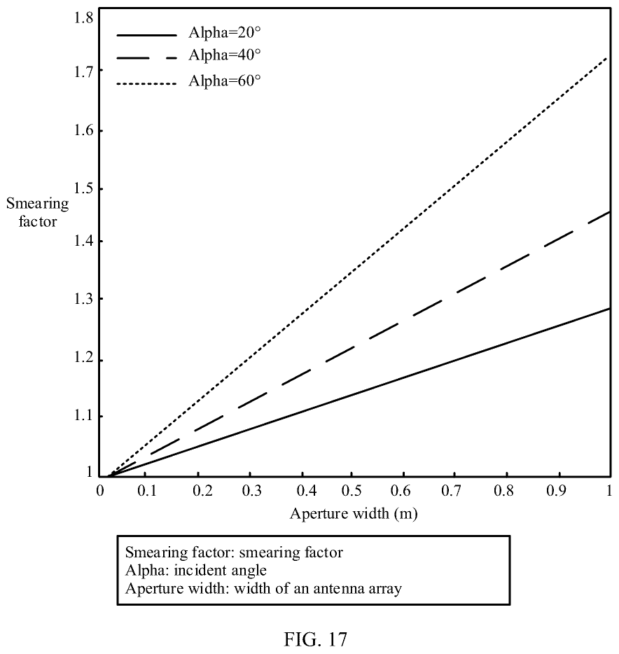

For example, FIG. 17 is a diagram of a relationship between a smearing factor, a length D of an antenna array, and an incident angle α according to an embodiment of this application. For a frequency band of 5 GHz, when an antenna array with a width of 1 m, and an incident angle of a signal is 60°, a maximum smearing factor may be 1.74 due to a limited signal bandwidth. However, in practice, a length of an antenna array is usually less than 1 m. For an antenna array that is more suitable for actual and that has a length of 0.4 m, a smearing factor is 1.29. In this case, the smearing factor is large but not very large.

It can be understood that, to implement the foregoing functions, the devices include corresponding hardware structures and/or software modules for executing the functions. A person skilled in the art should easily be aware that, in combination with units and algorithm steps of the examples described in embodiments disclosed in this specification, this application may be implemented by hardware or a combination of hardware and computer software. Whether a function is performed by hardware or hardware driven by computer software depends on particular applications and design constraints of the technical solutions. A person skilled in the art may use different methods to implement the described functions for each particular application, but it should not be considered that the implementation goes beyond the scope of this application.

In embodiments of this application, the AP may be divided into functional modules based on the foregoing method examples. For example, each functional module may be obtained through division based on a corresponding function, or two or more functions may be integrated into one processing module. The integrated module may be implemented in a form of hardware, or may be implemented in a form of a software functional module. It should be noted that, in embodiments of this application, module division is an example, and is merely a logical function division. In actual implementation, another division manner may be used.

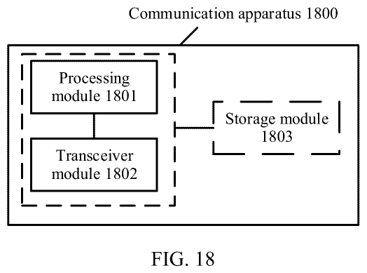

If the integrated module is used, refer to FIG. 18. FIG. 18 is a diagram of a structure of a communication apparatus according to an embodiment of this application. The communication apparatus 1800 may be applied to the method shown in FIG. 5. As shown in FIG. 18, the communication apparatus 1800 includes a processing module 1801 and a transceiver module 1802. The processing module 1801 may be one or more processors, and the transceiver module 1802 may be a transceiver or a communication interface. The communication apparatus may be configured to implement the AP in any one of the foregoing method embodiments, or configured to implement functions of the network element in any one of the foregoing method embodiments. The network element or network function may be a network element in a hardware device, a software function running on dedicated hardware, or a virtualization function instantiated on a platform (for example, a cloud platform). Optionally, the communication apparatus 1800 may further include a storage module 1803, configured to store program code and/or data of the communication apparatus 1800.

In an instance, when the communication apparatus is used as an AP or a chip used in an AP, and performs the steps performed by the AP in the foregoing method embodiments, the transceiver module 1802 is configured to support communication with a STA and the like, and the transceiver module specifically performs a sending and/or receiving action performed by the AP in FIG. 5. For example, the transceiver module supports the AP in performing step 501, and/or performing another process of the technology described in this specification. The processing module 1801 may be configured to support the communication apparatus 1800 in performing the processing actions in the foregoing method embodiments. For example, the processing module supports the AP in performing step 502, and/or performing another process of the technology described in this specification.

For example, the transceiver module 1802 is configured to obtain a first multi-carrier signal; and the processing module 1801 is configured to perform compensation on the first multi-carrier signal based on a channel state information phase difference of the first multi-carrier signal, to obtain a second multi-carrier signal, where a channel state information phase difference of the second multi-carrier signal is zero.

In a possible implementation, when the AP is a chip, the transceiver module 1802 may be a communication interface, a pin, a circuit, or the like. The communication interface may be configured to input to-be-processed data into a processor, and may output a processing result of the processor to the outside. During specific implementation, the communication interface may be a general-purpose input/output (general-purpose input/output, GPIO) interface, and may be connected to a plurality of peripheral devices (for example, a display (LCD), a camera (camera), a radio frequency (radio frequency, RF) module, and an antenna). The communication interface is connected to the processor through a bus.

The processing module 1801 may be a processor. The processor may execute computer-executable instructions stored in the storage module, so that the chip performs the method in the embodiment in FIG. 5.

Further, the processor may include a controller, an arithmetic unit, and a register. For example, the controller is mainly responsible for instruction decoding, and transmitting a control signal for an operation corresponding to the instructions. The arithmetic unit is mainly responsible for performing a fixed-point or floating-point arithmetic operation, a shift operation, a logic operation, and the like, and may also perform an address operation and address translation. The register is mainly responsible for saving a quantity of register operations, intermediate operation results, and the like that are temporarily stored during instruction execution. During specific implementation, a hardware architecture of the processor may be an application-specific integrated circuit (application-specific integrated circuit, ASIC) architecture, a microprocessor without interlocked piped stages architecture (microprocessor without interlocked piped stages architecture, MIPS), an advanced reduced instruction set computing machine (advanced RISC machine, ARM) architecture, a network processor (network processor, NP) architecture, or the like. The processor may be a single-core or multi-core processor.

The storage module may be a storage module inside the chip, for example, a register or a cache. Alternatively, the storage module may be a storage module located outside the chip, for example, a read-only memory (Read-Only Memory, ROM), another type of static storage device that can store static information and instructions, or a random access memory (Random Access Memory, RAM).

It should be noted that a function corresponding to each of the processor and the interface may be implemented by using a hardware design, may be implemented by using a software design, or may be implemented by a combination of software and hardware. This is not limited herein.

An embodiment of this application further provides a communication apparatus, including a processor, a memory, an input interface, and an output interface. The input interface is configured to receive information from another communication apparatus different from the communication apparatus, and the output interface is configured to output information to the another communication apparatus different from the communication apparatus. The processor invokes a computer program stored in the memory, to implement any embodiment shown in FIG. 5.

An embodiment of this application further provides a chip. The chip includes at least one processor and an interface. The processor is configured to read and execute instructions stored in a memory. When the instructions are run, the chip is enabled to perform any embodiment shown in FIG. 5.

An embodiment of this application further provides a computer-readable storage medium. The computer-readable storage medium stores a computer program, the computer program includes program instructions, and when the program instructions are executed by a computer, the computer is enabled to perform any embodiment shown in FIG. 5.

An embodiment of this application further provides a computer program product. When a computer reads and executes the computer program product, the computer is enabled to implement any embodiment shown in FIG. 5.

The foregoing units described as separate parts may or may not be physically separate, and parts displayed as units may or may not be physical units, may be located in one position, or may be distributed on a plurality of network units. Some or all of the units may be selected based on an actual requirement, to achieve the objectives of the solutions in embodiments of this application. In addition, the network element units in embodiments of this application may be integrated into one processing unit, or each of the units may exist alone physically, or two or more units are integrated into one unit. The integrated unit may be implemented in a form of hardware, or may be implemented in a form of a software network element unit.

When the integrated unit is implemented in the form of a software network element unit and sold or used as an independent product, the integrated unit may be stored in a computer-readable storage medium. Based on such an understanding, an essentially contributing part in the technical solutions of this application, or all or some of the technical solutions may be embodied in a form of a software product. The computer software product is stored in a storage medium, and includes several instructions for instructing a computer device (which may be a personal computer, a terminal device, a cloud server, a network device, or the like) to perform all or some of the steps of the method described in the foregoing embodiment of this application. The foregoing storage medium includes any medium that can store program code, such as a USB flash drive, a removable hard disk, a read-only memory (ROM, Read-Only Memory), a random access memory (RAM, Random Access Memory), a magnetic disk, or an optical disc. The foregoing descriptions are merely specific embodiments of this application, but are not intended to limit the protection scope of this application. Any modification or replacement readily figured out by a person skilled in the art within the technical scope disclosed in this application shall fall within the protection scope of this application. Therefore, the protection scope of this application shall be subject to the protection scope of the claims.

1. A multi-carrier signal processing method, wherein the method comprises:
obtaining a first multi-carrier signal; and
performing compensation on the first multi-carrier signal, based on a channel state information phase difference of the first multi-carrier signal, to obtain a second multi-carrier signal, wherein:
a channel state information phase difference of the second multi-carrier signal is zero; or
a phase difference of the second multi-carrier signal is zero.

2. The method according to claim 1, wherein the performing compensation on the first multi-carrier signal, based on a channel state information phase difference of the first multi-carrier signal, to obtain a second multi-carrier signal comprises:
performing true time delay compensation on channel state information of the first multi-carrier signal, based on the channel state information phase difference of the first multi-carrier signal, to obtain the second multi-carrier signal.

3. The method according to claim 1, wherein the performing compensation on the first multi-carrier signal, based on a channel state information phase difference of the first multi-carrier signal, to obtain a second multi-carrier signal comprises:
performing phase compensation on the first multi-carrier signal, based on the channel state information phase difference of the first multi-carrier signal, to obtain the second multi-carrier signal.

4. The method according to claim 1, wherein the performing compensation on the first multi-carrier signal, based on a channel state information phase difference of the first multi-carrier signal, to obtain a second multi-carrier signal comprises:
performing polynomial fit on the first multi-carrier signal, based on the channel state information phase difference of the first multi-carrier signal, to obtain the second multi-carrier signal.

5. The method according to claim 1, wherein the performing compensation on the first multi-carrier signal, based on a channel state information phase difference of the first multi-carrier signal, to obtain a second multi-carrier signal comprises:
performing polynomial fit on channel state information of the first multi-carrier signal, based on the channel state information phase difference of the first multi-carrier signal, to obtain the second multi-carrier signal.

6. The method according to claim 1, wherein the method further comprises:
performing imaging based on a plurality of second multi-carrier signals to obtain an image.

7. The method according to claim 6, wherein the performing imaging based on a plurality of second multi-carrier signals to obtain an image comprises:
averaging the plurality of second multi-carrier signals to obtain an average of the plurality of second multi-carrier signals; and
performing imaging based on the average to obtain the image.

8. The method according to claim 6, wherein the performing imaging based on a plurality of second multi-carrier signals to obtain an image comprises:
separately performing imaging based on the plurality of second multi-carrier signals to obtain a plurality of imaged sub-images; and
averaging the plurality of imaged sub-images to obtain the imaged image.

9. A chip, wherein the chip comprises at least one processor coupled to one or more memories, the one or more memories storing programming instructions for execution by the at least one processor to perform operations comprising:
obtaining a first multi-carrier signal; and
performing compensation on the first multi-carrier signal, based on a channel state information phase difference of the first multi-carrier signal, to obtain a second multi-carrier signal, wherein:
a channel state information phase difference of the second multi-carrier signal is zero; or
a phase difference of the second multi-carrier signal is zero.

10. The chip according to claim 9, wherein the performing compensation on the first multi-carrier signal, based on a channel state information phase difference of the first multi-carrier signal, to obtain a second multi-carrier signal comprises:
performing true time delay compensation on channel state information of the first multi-carrier signal, based on the channel state information phase difference of the first multi-carrier signal, to obtain the second multi-carrier signal.

11. The chip according to claim 9, wherein the performing compensation on the first multi-carrier signal, based on a channel state information phase difference of the first multi-carrier signal, to obtain a second multi-carrier signal comprises:
performing phase compensation on the first multi-carrier signal, based on the channel state information phase difference of the first multi-carrier signal, to obtain the second multi-carrier signal.

12. The chip according to claim 9, wherein the performing compensation on the first multi-carrier signal, based on a channel state information phase difference of the first multi-carrier signal, to obtain a second multi-carrier signal comprises:
performing polynomial fit on the first multi-carrier signal, based on the channel state information phase difference of the first multi-carrier signal, to obtain the second multi-carrier signal.

13. The chip according to claim 9, wherein the performing compensation on the first multi-carrier signal, based on a channel state information phase difference of the first multi-carrier signal, to obtain a second multi-carrier signal comprises:
performing polynomial fit on channel state information of the first multi-carrier signal, based on the channel state information phase difference of the first multi-carrier signal, to obtain the second multi-carrier signal.

14. The chip according to claim 9, wherein the operations comprise performing imaging based on a plurality of second multi-carrier signals to obtain an image.

15. The chip according to claim 14, wherein the performing imaging based on a plurality of second multi-carrier signals to obtain an image comprises:
averaging the plurality of second multi-carrier signals to obtain an average of the plurality of second multi-carrier signals; and
performing imaging based on the average to obtain the image.

16. The chip according to claim 14, wherein the performing imaging based on a plurality of second multi-carrier signals to obtain an image comprises:
separately performing imaging based on the plurality of second multi-carrier signals to obtain a plurality of imaged sub-images; and
averaging the plurality of imaged sub-images to obtain the imaged image.

17. A non-transitory computer-readable storage medium storing programming instructions for execution by at least one processor, that when executed by the at least one processor, cause a computer to perform operations comprising:
obtaining a first multi-carrier signal; and
performing compensation on the first multi-carrier signal, based on a channel state information phase difference of the first multi-carrier signal, to obtain a second multi-carrier signal, wherein:
a channel state information phase difference of the second multi-carrier signal is zero; or
a phase difference of the second multi-carrier signal is zero.

18. The non-transitory computer-readable storage medium according to claim 17, wherein the performing compensation on the first multi-carrier signal, based on a channel state information phase difference of the first multi-carrier signal, to obtain a second multi-carrier signal comprises:
performing true time delay compensation on channel state information of the first multi-carrier signal, based on the channel state information phase difference of the first multi-carrier signal, to obtain the second multi-carrier signal.

19. The non-transitory computer-readable storage medium according to claim 17, wherein the performing compensation on the first multi-carrier signal, based on a channel state information phase difference of the first multi-carrier signal, to obtain a second multi-carrier signal comprises:
performing phase compensation on the first multi-carrier signal, based on the channel state information phase difference of the first multi-carrier signal, to obtain the second multi-carrier signal.

20. The non-transitory computer-readable storage medium according to claim 17, wherein the performing compensation on the first multi-carrier signal, based on a channel state information phase difference of the first multi-carrier signal, to obtain a second multi-carrier signal comprises:
performing polynomial fit on the first multi-carrier signal, based on the channel state information phase difference of the first multi-carrier signal, to obtain the second multi-carrier signal.
